(19) United States
(12) Patent Application Publication
(10) Pub. No.: US 2006/0068660 A1
(43) Pub. Date: Mar. 30, 2006

(54) Anti-radiation protection mat and relative manufacturing method

(75) Inventor: Nicola Limardo, Novara (IT)

Correspondence Address: JACOBSON HOLMAN PLLC, 400 SEVENTH STREET N.W., SUITE 600, WASHINGTON, DC, 20004, US

(73) Assignee: EDIL NATURA S.A.S.DI N.LIMARDO & C.

(21) Appl. No.: 10/537,998

(22) PCT Filed: Feb. 18, 2004
(86) PCT No.: PCT/EP04/01618

§ 371 Date: Jun. 9, 2005

(30) Foreign Application Priority Data
Mar. 24, 2004 (IT) NO2003A000007

(51) Int. Cl. D03D 15/00; B32B 15/14; B32B 5/26

(52) U.S. Cl. 442/6; 442/10; 442/11

(57) ABSTRACT

A mat for the protection against radiations is described, which comprises a mesh (2) made of copper fibres (3) interlaced with carbon fibres (4), and a solution (5) with liquid moss of oak placed on said mesh (2).

The present invention refers to a mat for the protection against radiations and to the relative manufacturing method.

The effects that radiations of various kind, as electromagnetic radiations, ionising and non ionising radiations, can cause on the human body or on various kind of equipment, for example medical equipment, are generally known. To this purpose protection elements have been produced that however offer positive results only for some types of radiations and not for others.

In the past few years the effects of the radiations coming from the subsurface are also being evaluated. Said radiations comprise Hartmann's bands and nodes (that is the points of intersection of the bands), and Curry's bands and nodes and the radiations due to the underground water-bearing strata in motion.

Hartmann's global grid consists of different meshes that have origin in the heart's subsurface and get down to the troposphere. Each mesh is oriented according to the axes North/South and East/West. Each mesh has normally a variable shape and the thickness of the bands that form the meshes is substantially of 21 cm.

The Curry's grid comprises meshes that are distant approximately 9 meters from each other in a direction inclined by approximately 45° as regards the cardinal points and having a width of approximately 50 cm.

The radiations produced by underground, if absorbed for long periods of time, cause degenerative effects in the human body and can be cause of diseases.

A protection mat against the earth electromagnetic radiations is described in WO 92/11899. Said mat comprises a grid of copper made with electrolytic threads of copper for the weft and strips of copper-cadmium wound in spiral on a core of polyester or other type of insulator for the warp. The mat comprises a silver-plated layer arranged between one layer of cotton fabric and one of felt that are connected together with a quilt. The scope of the mat is to absorb the electrostatic energy and to discharge it into the environment through the copper grid and a ground connection of the same. The mat repels by reflection toward the ground the electromagnetic waves emitted by it through the silver-plated layer.

In view of the state of the art herein described, object of the present invention is to provide a mat for the protection against the any type of radiations, ionising and non ionising, that is simple to make and does not have any ground connection.

According to the present invention, such object is attained by means of a mat for the protection against radiations, said mat comprising a mesh made up of copper fibres interlaced with carbon fibres, characterised in that it comprises a solution with liquid oak moss positioned on said mesh.

According to the present invention it is also possible to provide a method for the fabrication of a mat for the protection against radiations, said method comprising a first stage for the creation of a mesh made up of copper fibres interlaced with carbon fibres, characterised in that it comprises a second stage for the dynamization of said mesh and a third stage for the positioning of a solution comprising liquid oak moss on said mesh.

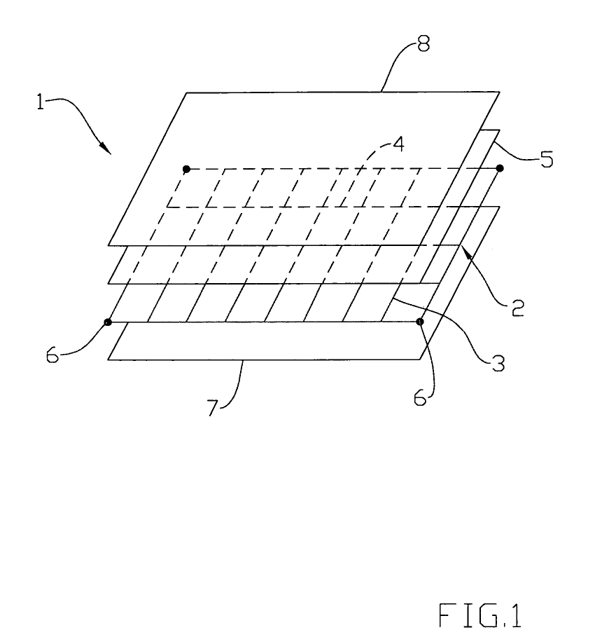

The characteristics and the advantages of the present invention will become evident from the following detailed description of an embodiment thereof, that is illustrated as a non-limiting example in the annexed FIG. 1 that schematically shows the sequence of the layers of a mat according to the invention.

In FIG. 1 a mat 1 for the protection against radiations according to the invention is described. Said mat 1 comprises a mesh 2 made up of an interlace of copper fibres 3 and carbon fibres 4. The copper fibres 3 are longitudinally woven with a fibre distance (that is the distance from a fibre to the adjacent fibre) variable from 1 millimetre to 3 millimetres and have a thickness variable from 0.2 millimetres and 0.4 millimetres. The carbon fibres 4 are transversally warped with a fibre distance variable from 2 millimetres and 5 millimetres and a fibre thickness variable from 0.1 millimetres and 0.3 millimetres. The carbon fibres 4 can preferably be encapsulated with plastic material.

The mesh 2 is subjected to a dynamization process (that is an oscillation of the product in order to make the molecules dynamic thus increasing their energy) by means of a first liquid solution placed on the mesh. Said first liquid solution is preferably made up of a copper solution at the liquid state, as for example the solution known on the market by the name of CUPRUM D1000. The dynamization is carried out by placing on the mesh, by spreading or spraying, said first solution in a quantity of 10 ml per square meter.

The mesh 2 can be subjected to an additional dynamization by means of a second liquid solution, preferably made up of a silicon solution at the liquid state, as for instance the solution known on the market by the name of SILICEA D1000. The dynamization is carried out by placing on the mesh, by spreading or spraying, said second solution in a quantity of 10 millilitres per square meter.

The dynamization allows to improve the shielding property of the mat. In fact the radiations are emitted by a source with a positive polarity (dextro-rotary) or negative (levo-rotary) and the dynamization of the mat allows to neutralise said polarity by creating an equal and contrary one which nullifies the polarity of the radiation to be shielded. This happens in particular with electromagnetic or earth radiations with a frequency above one hundred kilohertz.

On the dynamized mesh another solution 5 comprising oak moss at the liquid state is placed. Said solution is obtained from oak moss and Propolis (nectar of the bees) by addition of water having a PH between 6 and 7 and a dry residue lower than or equal to 30 mg/l. After the hot mixing of said products and a subsequent filtering, a liquid product is obtained that has energetic characteristics and intrinsic frequencies similar to the ones of the oak moss at solid state.

This solution is then sprayed or spread on the dynamized mesh so as to create an antibacterial ability in the environment.

On the mat 1 in addition some photonised water 6, that is electrically charged water, is preferably placed. Said photonised water is placed in traces at pre-established points of the mat, for instance if the mat is rectangular the photonised water is positioned on the four corners.

The mat thus made is ready for building construction. The mat 1 according to the invention, in order to be used for interior decoration (it can be put inside seats or chairs, or even curtains), must be finished with a quilt fabric material or applied externally. Normally a cotton cloth 7 connected with the carbon and copper fibre mesh can be provided.

The mat is preferably provided with a silver nitrate layer 8 having a thickness variable from 40 millimetres and 60 millimetres. The silver nitrate layer is arranged on the surface of the mat opposite to the one in which the cotton cloth 7 is placed.

The mat according to the invention can also be placed in car seats or on the roof or also in several garments as shoes.

The mat thus made creates a protection barrier against earth and electromagnetic radiations since it provides to deflect said radiations.

1. A anti-radiation protection mat (1) comprising a mesh (2) made of copper fibres (3) interlaced with carbon fibres (4), characterised in that it comprises a solution (5) with liquid oak moss placed on said mesh (2).

2. The mat according to claim 1, characterised in that it comprises a cotton cloth (7) connected with said mat (1).

3. The mat according to claim 1, characterised in that it comprises a silver nitrate cloth (8) connected with said mat (1).

4. The mat according to claim 2, characterised in that said cotton cloth (7) and said silver nitrate cloth (8) are arranged on opposite surfaces of the mat (1).

5. The mat according to claim 1, characterised in that it comprises traces of photonised water (6) in prefixed points of said mat (1).

6. A method for manufacturing a mat (1) for the protection against radiations, said method comprising a first stage for the creation of a mesh (2) made up of copper fibres (3) interlaced with carbon fibres (4), characterised in that it comprises a second stage for the dynamization of said mesh (2) and a third stage for the arrangement of a solution (5) comprising liquid oak moss on said mesh.

7. The method according to claim 6, characterised in that said stage of dynamization of the mesh (2) comprises at least the arrangement of an element on said mesh (2) and the subsequent oscillation of the mesh (2).

8. The method according to claim 7, characterised in that said stage of dynamization of the mesh (2) comprises a first arrangement of a first element on said mesh (2) and the subsequent oscillation of the mesh and a second arrangement of a second element on said mesh (2) and the subsequent oscillation of the mesh.

9. The method according to claim 8, characterised in that said first element suitable to dynamize said mesh is a liquid solution of copper and said second element is a liquid silicon solution.

10. The method according to claim 6, characterised in that it comprises the placing of photonised water (6) in prefixed points of said mat (1).
